(19) United States
(12) Patent Application Publication
(10) Pub. No.: US 2014/0301335 A1
(43) Pub. Date: Oct. 9, 2014

(54) CONTROL SIGNALING TRANSMISSION METHOD, BASE STATION, TERMINAL AND SYSTEM

(71) Applicant: CHINA MOBILE COMMUNICATIONS CORPORATION, Beijing (CN)

(72) Inventors: Zhihua Shi, Beijing (CN); Xiaodong Shen, Beijing (CN); Jianjun Liu, Beijing (CN); Chengkang Pan, Beijing (CN); Qixing Wang, Beijing (CN); Guangyi Liu, Beijing (CN)

(21) Appl. No.: 14/354,194

(22) PCT Filed: Oct. 22, 2012
(86) PCT No.: PCT/CN2012/083321

§ 371 Date: Apr. 25, 2014

(30) Foreign Application Priority Data
Oct. 27, 2011 (CN) 201110332505.4

(51) Int. Cl. H04L 5/00; H04W 72/04

(52) U.S. Cl. CPC H04L 5/0053; H04W 72/0413
USPC 370/329

(57) ABSTRACT

Provided in an embodiment of the present invention are a control signaling transmission method, base station, terminal and system, comprising: when the terminal operates in an E-PDCCH mode, the base station may transmit a control signaling to the terminal via a resource corresponding to the E-PDCCH and a resource corresponding to common search space; that is, in the E-PDCCH mode, the control signaling transmission method on the resource corresponding to the common search space is maintained, thus providing an effective mechanism to transmit the control signaling of the terminal operating in the E-PDCCH mode.

This application claims the benefit of Chinese Patent Application No. 201110332505.4, filed with the State Intellectual Property Office of People's Republic of China on Oct. 27, 2011 and entitled “Method of transmitting control signaling, base station, user equipment and system”, the content of which is hereby incorporated by reference in its entirety.

### FIELD

The present invention relates to the field of wireless communications and particularly to a method of transmitting control signaling, a base station, a user equipment and a system.

### BACKGROUND

In Long Term Evolution (LTE) systems of Releases 8, 9 and 10 (R8/9/10), a Physical Downlink Control Channel (PDCCH) is transmitted in first several Orthogonal Frequency Division Multiplexing (OFDM) symbols and data is transmitted in subsequent symbols in a pair of Transmission Time Intervals (TTIs) (two slots). As per a different system configuration, a PDCCH in a conventional LTE system may occupy 1 to 3 OFDM symbols (more than 10 Physical Resource Blocks (PRBs) of the system in the downlink) or 2 to 4 OFDM symbols (10 PRBs or less of the system in the downlink), where a particular number of occupied OFDM symbols is indicated by Physical Control Format Indicator Channel (PCFICH) information. A User Equipment (UE) can determine the number of OFDM symbols occupied by the PDDCH in transmission at a current instance of time and the serial number of a starting OFDM symbol for data transmission by detecting the PCFICH information. As illustrated in FIG. 1, there is illustrated a schematic diagram of transmission of a PDCCH at an instance of time, where first three OFDM symbols are occupied by the PDCCH.

The technology of Multiple-Input Multiple-Output (MIMO) has been widely applied since the birth of the LTE R8, and an operating mechanism of Multi-User Multiple-Input Multiple-Output (MIMO) has been enhanced and optimized in the LTE R9 and the LTE R10. A significant increase in the number of user equipments operating in the MU-MIMO mechanism is expected in the LTE R9 and the LTE R10. In order to support concurrent transmission by a large number of user equipments, the capacity of PDCCHs in the system is challenged.

For some new deployment scenarios, for example, a scenario in which a macro cell and multiple Radio Remote Heads (RRHs) share the same cell identifier (ID), that is, they are in the same cell, the capacity of PDCCHs may be limited and consequently fail to support a large number of user equipments, so there is a demand for a higher capacity of PDCCHs.

Thus at present an Enhanced Physical Downlink Control Channel (E-PDCCH) has come under discussion in the LTE R11, and a general idea of the enhanced PDCCH is to put information of a control channel onto a resource of a Physical Downlink Shared Channel (PDSCH) in the R8/9/10 for transmission, and currently there are some solutions thereto, particularly as illustrated in FIG. 2 and FIG. 3, where in FIG. 2, a cell grid denoted by 1 represents a resource occupied by a PDCCH, a cell grid denoted by 13 represent a resource occupied by both a PDCCH and an E-PDCCH, and each of cell grids denoted by 2 and 3 represents a resource occupied by an E-PDCCH; and in FIG. 3, a cell grid denoted by 1 represents a resource occupied by a PDCCH, a cell grid denoted by 13 represent a resource occupied by both a PDCCH and an E-PDCCH, and each of cell grids denoted by 2, 3, 4 and 5 represents a resource occupied by an E-PDCCH.

However there has been so far neither detailed design solution to an E-PDCCH nor design solution to an interrelationship between an E-PDCCH and a conventional PDCCH for their effective cooperation in operation.

### SUMMARY

Embodiments of the invention provide a method of transmitting control signaling, a base station, a user equipment and a system so as to transmit control signaling of a user equipment operating in an E-PDCCH mode.

A method of transmitting control signaling includes:

a base station instructing a user equipment via signaling to switch to an enhanced physical downlink control channel mode, wherein the signaling instructs the user equipment operating in the enhanced physical downlink control channel mode to detect control signaling over a resource corresponding to an enhanced physical downlink control channel and a resource corresponding to a common search space of a physical downlink control channel (PDCCH); and

the base station transmitting the control signaling to the user equipment over the resource corresponding to the enhanced physical downlink control channel and the resource corresponding to the common search space upon reception of a feedback message of the user equipment,

wherein the feedback message notifies the base station that the user equipment has switched to the enhanced physical downlink control channel mode.

A base station includes:

a first sending module configured to instruct a user equipment via signaling to switch to an enhanced physical downlink control channel mode, wherein the signaling instructs the user equipment operating in the enhanced physical downlink control channel mode to detect control signaling over a resource corresponding to an enhanced physical downlink control channel and a resource corresponding to a common search space of a physical downlink control channel (PDCCH);

a reception module configured to receive a feedback message of the user equipment, wherein the feedback message notifies the base station that the user equipment has switched to the enhanced physical downlink control channel mode; and

a signaling transmission module configured to transmit the control signaling to the user equipment over the resource corresponding to the enhanced physical downlink control channel and the resource corresponding to the common search space after the reception module receives the feedback message.

A user equipment includes:

a first reception module configured to receive signaling of a base station to instruct the user equipment to switch to an enhanced physical downlink control channel mode, wherein the signaling instructs the user equipment operating in the enhanced physical downlink control channel mode to detect control signaling over a resource corresponding to an enhanced physical downlink control channel and a resource corresponding to a common search space of a physical downlink control channel (PDCCH);

a first sending module configured to send a feedback message to the base station, wherein the feedback message notifies the base station that the user equipment has switched to the enhanced physical downlink control channel mode, and

a second reception module configured to receive the control signaling transmitted by the base station over the resource corresponding to the enhanced physical downlink control channel and the resource corresponding to the common search space of the physical downlink control channel.

A system for transmitting control signaling includes a base station and a user equipment, wherein:

the base station is configured to instruct the user equipment via signaling to switch to an enhanced physical downlink control channel mode, wherein the signaling instructs the user equipment operating in the enhanced physical downlink control channel mode to detect control signaling over a resource corresponding to an enhanced physical downlink control channel and a resource corresponding to a common search space of a physical downlink control channel (PDCCH), and to transmit the control signaling to the user equipment over the resource corresponding to the enhanced physical downlink control channel and the resource corresponding to the common search space upon reception of a feedback message of the user equipment, wherein the feedback message notifies the base station that the user equipment has switched to the enhanced physical downlink control channel mode; and

the user equipment is configured to receive the signaling to instruct the user equipment to switch to the enhanced physical downlink control channel mode, and the control signaling, transmitted by the base station, and to return the feedback message to the base station.

With the solutions according to the embodiments of the invention, when a user equipment operates in an E-PDCCH mode, a base station can transmit control signaling to the user equipment over a resource corresponding to an E-PDCCH and a resource corresponding to a common search space, that is, a scheme to transmit control signaling over a resource corresponding to a common search space is reserved in the E-PDCCH mode to thereby propose an effective mechanism to transmit control signaling of the user equipment operating in the E-PDCCH mode.

### BRIEF DESCRIPTION OF THE DRAWINGS

FIG. 1 is a schematic diagram of transmission of a PDCCH at an instance of time in the prior art;

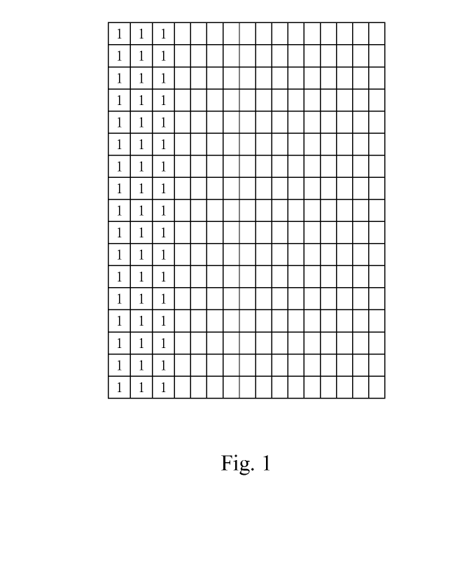

FIG. 2 is a schematic diagram of transmission of an E-PDCCH at an instance of time in the prior art;

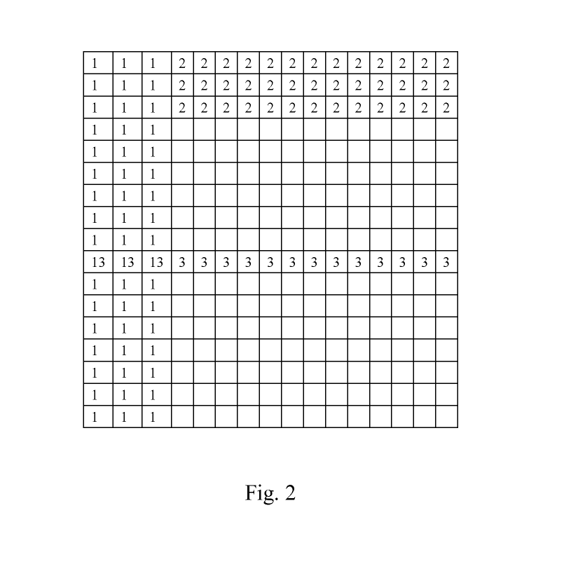

FIG. 3 is a schematic diagram of transmission of an E-PDCCH at an instance of time in the prior art;

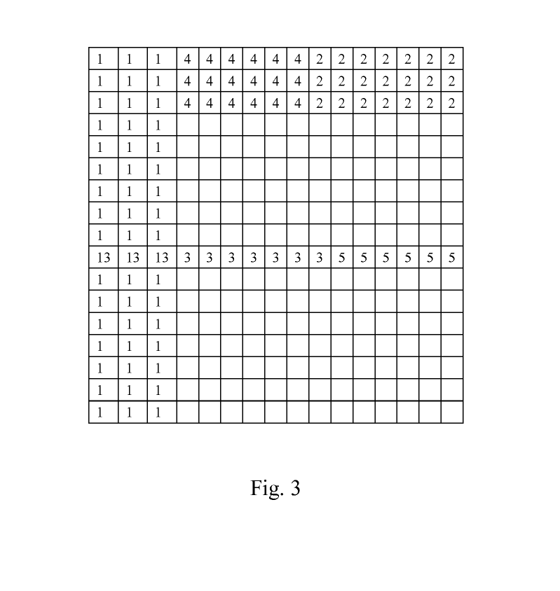

FIG. 4 is a flow chart of a method of transmitting control signaling according to a first embodiment of the invention;

FIG. 5 is a schematic structural diagram of a base station according to a second embodiment of the invention;

FIG. 6 is a schematic structural diagram of a user equipment according to a third embodiment of the invention; and

FIG. 7 is a schematic structural diagram of a system for transmitting control signaling according to a fourth embodiment of the invention.

### DETAILED DESCRIPTION

An effective signaling transmission mechanism has been proposed in solutions according to embodiments of the invention, where a user equipment in an E-PDCCH mode can be enabled, in connection with a scheme to transmit control signaling over a resource corresponding to a common search space, to switch between the E-PDCCH mode and a PDCCH mode by addressing the problem of an ambiguous period in switching between the PDCCH mode and the E-PDCCH mode to thereby switch smoothly between the PDCCH mode and the E-PDCCH mode and avoid the problems of an ambiguous period and an E-PDCCH resource confliction due to an indeterminate operating status of the user equipment in a procedure of updating a parameter configuration of an E-PDCCH and a process of handing the user equipment over between cells.

The solutions according to the invention will be described below in details with reference to the drawings and respective embodiments thereof.

### First Embodiment

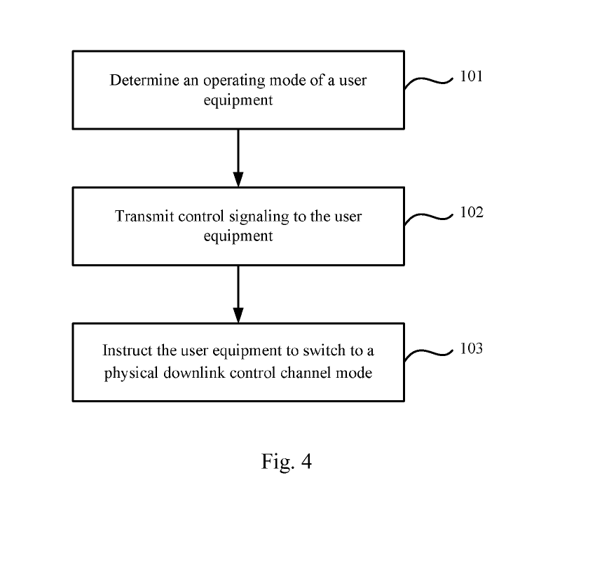

A first embodiment of the invention provides a method of transmitting control signaling, and FIG. 4 illustrates a flow of steps in the method including steps 101 and 102.

The step 101 is to determine an operating mode of a user equipment.

In this step, it can be determined whether the user equipment operates in an enhanced physical downlink control channel mode, and the flow can proceed to the step 12 if the user equipment is determined to operate in the enhanced physical downlink control channel mode.

When a base station (a network) and the user equipment operate in an LTE R8/9/10 operating mechanism, the base station can notify the user equipment (UE) that control signaling will be transmitted to the user equipment over a preset physical resource, and particularly the base station can notify the user equipment (UE) via first Radio Resource Control (RRC) signaling that control signaling will be transmitted to the user equipment over a preset physical resource, to instruct the UE to enter the enhanced physical downlink control channel mode (which can be denoted as the E-PDCCH mode), and the UE can return a corresponding feedback message (e.g., a first RRC feedback message which is an RRC feedback message for the first RRC signaling) to the base station upon reception of the RRC signaling to notify the base station that the user equipment has switched to the enhanced physical downlink control channel mode, and the UE can detect the control signaling over the preset physical resource, that is, operate in the E-PDCCH mode, as instructed by the first RRC signaling.

In an existing PDCCH transmission mode in the LTE R8/9/10, control signaling can be transmitted in two different search spaces including:

a User Equipment (UE)-specific search space in which control signaling of a specific User Equipment (UE) can be transmitted; and

a common search space in which control signaling common to all the user equipments can be transmitted or in which control signaling of any UE can be transmitted.

In this embodiment, the preset physical resource includes both a resource corresponding to an enhanced physical downlink control channel and a resource corresponding to a common search space of a physical downlink control channel, that is, the user equipment operating in the E-PDCCH mode detects control signaling over the resource corresponding to the enhanced physical downlink control channel and control signaling over the resource corresponding to the common search space of the physical downlink control channel.

In this step, the base station can determine that the user equipment operates in the enhanced physical downlink control channel mode upon reception of the feedback (the first RRC feedback message) corresponding to the user equipment.

The step 102 is to transmit control signaling to the user equipment.

In this embodiment, the base station can transmit control signaling to the user equipment over a resource corresponding to an enhanced physical downlink control channel and a resource corresponding to a common search space of a physical downlink control channel upon determining that the user equipment operates in the enhanced physical downlink control channel mode.

Furthermore after instructing the user equipment via the first RRC signaling to switch to the enhanced physical downlink control channel mode and before receiving the first RRC feedback message of the user equipment, the base station stays in an ambiguous period during which the UE is not certain to operate in the E-PDCCH mode or the PDCCH mode at each particular instance of time and the base station can transmit the control signaling to the user equipment over the resource corresponding to the common search space.

This embodiment can further include the following step 103.

The step 103 is to instruct the user equipment to switch to a physical downlink control channel model.

The base station can instruct the user equipment to switch from the enhanced physical downlink control channel mode to a conventional physical downlink control channel mode (which can be denoted as a PDCCH mode), and particularly the base station can instruct the user equipment via second RRC signaling to switch from the enhanced physical downlink control channel mode to the physical downlink control channel mode, and after instructing the user equipment to switch from the enhanced physical downlink control channel mode to the physical downlink control channel mode and before receiving a feedback message (e.g., a second RRC feedback message which is an RRC feedback information for the second RRC signaling) of the user equipment, the base station stays in an ambiguous period during which the UE is not certain to operate in the E-PDCCH mode or the PDCCH mode at each particular instance of time and the base station can transmit the control signaling to the user equipment over the resource corresponding to the common search space, where the second RRC feedback message notifies the base station that the user equipment has switched to the physical downlink control channel mode.

Thus in this embodiment, the base station can transmit the control signaling to the user equipment over the resource corresponding to the common search space after instructing the user equipment to switch from the enhanced physical downlink control channel mode to the physical downlink control channel mode and before receiving the second RRC feedback message of the user equipment.

The base station can transmit the control signaling to the user equipment over the resource corresponding to the common search space or a resource corresponding to the UE-specific search space after receiving the second RRC feedback message of the user equipment.

When the user equipment operates in the enhanced physical downlink control channel mode, the UE can process the control signaling in different schemes while the UE is being handed over from a current cell to an adjacent cell.

In a scheme, before (or at the same time as) issuing a handover instruction to the UE, the base station instructs the UE to switch to the conventional PDCCH mode and after determining that the UE has finished the handover, the base station decides from a UE feedback and a system condition whether to instruct the UE to switch to the E-PDCCH mode. In this scheme, the control signaling is transmitted as in the step 103 in the course of the user equipment switching from the E-PDCCH mode to the conventional PDCCH mode as instructed (e.g., via the relevant RRC signaling) by the base station, that is, the control signaling is transmitted to the user equipment over the resource corresponding to the common search space before switching is finished, and the control signaling is transmitted to the user equipment over the resource corresponding to the common search space or the resource corresponding to the UE-specific search space after switching is finished. The control signaling is transmitted as in the step 102 in the course of the user equipment switching from the conventional PDCCH mode to the E-PDCCH mode as instructed (e.g., via the relevant RRC signaling) by the base station, that is, the control signaling is transmitted to the user equipment over the resource corresponding to the common search space before switching is finished, and the control signaling is transmitted to the user equipment over the resource corresponding to the enhanced physical downlink control channel and the resource corresponding to the common search space after switching is finished.

In another scheme, the base station sends neither PDCCH nor E-PDCCH switch instruction. In this scheme, the base station transmits the control signaling to the user equipment over the resource corresponding to the common search space after instructing the user equipment to be handed over from the current cell to the adjacent cell and before determining that the user equipment has been handed over to the adjacent cell. After determining that the user equipment has been handed over to the adjacent cell, the base station judges whether a corresponding parameter configuration of the enhanced physical downlink control channel before the user equipment is handed over is available, and if so, that is, there is no confliction with any other user equipment in the adjacent cell, then the base station transmits the control signaling to the user equipment over the resource corresponding to the enhanced physical downlink control channel and the resource corresponding to the common search space; otherwise, if it is determined that there is a confliction of the parameter configuration with another user equipment in the adjacent cell, the base station can instruct the user equipment via a higher-layer instruction to update the parameter configuration of the enhanced physical downlink control channel.

After the user equipment is handed over from the current cell to the adjacent cell, the base station instructs the user equipment via the higher-layer instruction to update the parameter configuration of the enhanced physical downlink control channel, or the base station updates the parameter configuration corresponding to the E-PDCCH, e.g., an E-PDCCH search space of the UE, via the higher-layer instruction, due to the confliction of the parameter configuration.

The base station can transmit the control signaling over the resource corresponding to the common search space after instructing the user equipment via the higher-layer instruction to update the parameter configuration of the enhanced physical downlink control channel and before receiving a feedback message of the user equipment for the higher-layer instruction, where the feedback message for the higher-layer instruction notifies the base station that the user equipment has updated the parameter configuration of the enhanced physical downlink control channel.

The base station can transmit the control signaling to the user equipment according to the updated parameter configuration after receiving the feedback message of the user equipment for the higher-layer instruction.

With the solution according to the first embodiment of the invention, not only a scheme to transmit control signaling to the user equipment in various statuses can be defined to thereby address the problem of an ambiguous period due to an indeterminate operating mode of the user equipment, but also blind detection in PDCCH and E-PDCCH search spaces can be avoided to thereby low the complexity of detection by the UE and consequently a cost of the equipment.

The following apparatuses and system are provided based upon the same inventive idea as the first embodiment of the invention.

### Second Embodiment

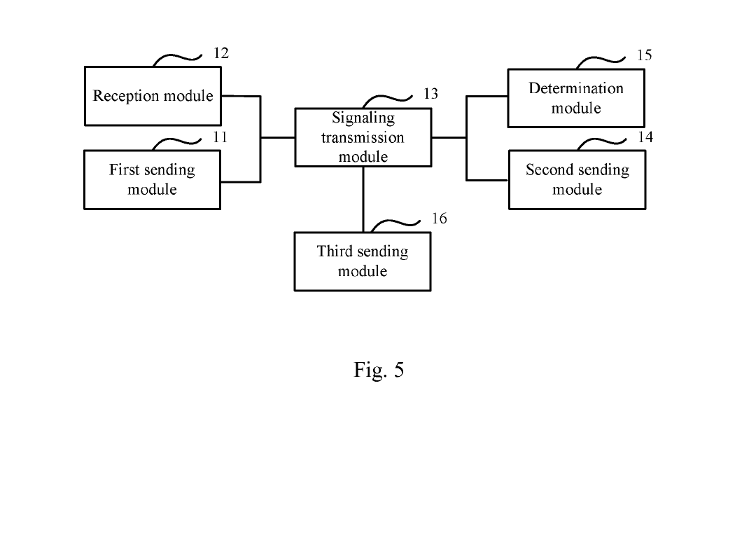

A second embodiment of the invention provides a base station, and as illustrated in FIG. 5, there is illustrated a schematic structural diagram of the base station including a first sending module 11, a reception module 12, and a signaling transmission module 13.

The first sending module 11 is configured to instruct a user equipment via signaling to switch to an enhanced physical downlink control channel mode, where the signaling instructs the user equipment operating in the enhanced physical downlink control channel mode to detect control signaling over a resource corresponding to an enhanced physical downlink control channel and a resource corresponding to a common search space of a physical downlink control channel (PDCCH);

The reception module 12 is configured to receive a feedback message of the user equipment, where the feedback message notifies the base station that the user equipment has switched to the enhanced physical downlink control channel mode; and

The signaling transmission module 13 is configured to transmit the control signaling to the user equipment over the resource corresponding to the enhanced physical downlink control channel and the resource corresponding to the common search space after the reception module receives the feedback message.

The first sending module 11 is further configured to instruct the user equipment via first Radio Resource Control (RRC) signaling to switch to the enhanced physical downlink control channel mode.

The reception module 12 is further configured to receive a first RRC feedback message of the user equipment.

The signaling transmission module 13 is further configured to transmit the control signaling to the user equipment over the resource corresponding to the common search space after the first sending module instructs the user equipment to switch to the enhanced physical downlink control channel mode and before the reception module receives the first RRC feedback message of the user equipment.

The first sending module 11 is further configured to instruct the user equipment via second RRC signaling to switch from the enhanced physical downlink control channel mode to a physical downlink control channel mode.

The reception module 12 is further configured to receive a second RRC feedback message of the user equipment, where the second RRC feedback message notifies the base station that the user equipment has switched to the physical downlink control channel mode.

The signaling transmission module 13 is further configured to transmit the control signaling to the user equipment over the resource corresponding to the common search space after the first sending module instructs the user equipment to switch from the enhanced physical downlink control channel mode to the physical downlink control channel mode and before the reception module receives the second RRC feedback message of the user equipment.

The base station further includes a second sending module 14, a determination module 15 and a third sending module 16.

The second sending module 14 is configured to instruct the user equipment via a handover instruction to be handed over from a current cell to an adjacent cell.

The determination module 15 is configured to determine whether the user equipment has been handed over to the adjacent cell.

The signaling transmission module 13 is further configured to transmit the control signaling to the user equipment over the resource corresponding to the common search space after the second sending module instructs the user equipment to be handed over from the current cell to the adjacent cell and before the determination module determines that the user equipment has been handed over to the adjacent cell, and after the determination module determines that the user equipment has been handed over to the adjacent cell, to judge whether a corresponding parameter configuration of the enhanced physical downlink control channel before the user equipment is handed over is available, and if so, to transmit the control signaling to the user equipment over the resource corresponding to the enhanced physical downlink control channel and the resource corresponding to the common search space; otherwise, to trigger the third sending module 16.

The third sending module 16 is configured to instruct the user equipment via a higher-layer instruction to update the parameter configuration of the enhanced physical downlink control channel.

The reception module 12 is further configured to receive a feedback message of the user equipment for the higher-layer instruction, where the feedback message for the higher-layer instruction notifies the base station that the user equipment has updated the parameter configuration.

The signaling transmission module 13 is further configured to transmit the control signaling to the user equipment over the resource corresponding to the common search space after the third sending module included in the base station instructs the user equipment via the higher-layer instruction to update the parameter configuration of the enhanced physical downlink control channel and before the reception module receives the feedback message of the user equipment for the higher-layer instruction, and to transmit the control signaling according to the updated parameter configuration after the reception module receives the feedback message of the user equipment for the higher-layer instruction.

### Third Embodiment

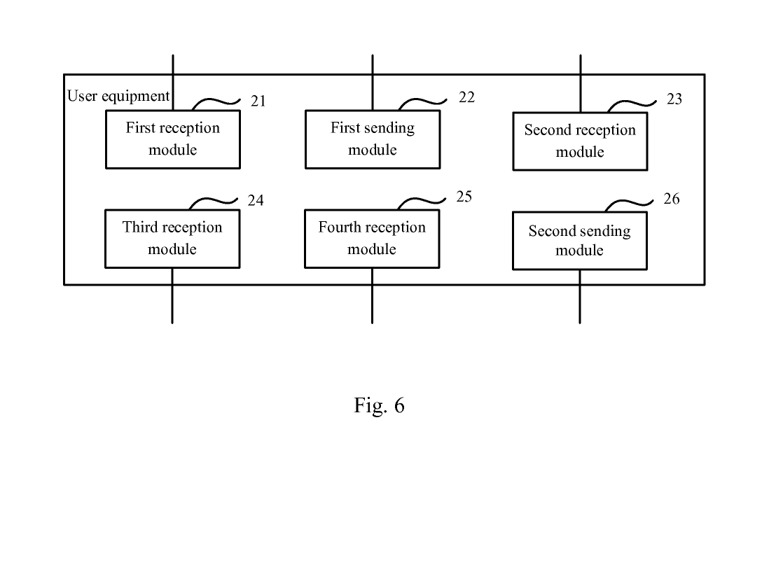

A third embodiment of the invention provides a user equipment, and as illustrated in FIG. 6, there is illustrated a schematic structural diagram of the user equipment including a first reception module 21, a first sending module 22, and a second reception module 23.

The first reception module 21 is configured to receive signaling of a base station to instruct the user equipment to switch to an enhanced physical downlink control channel mode, where the signaling instructs the user equipment operating in the enhanced physical downlink control channel mode to detect control signaling over a resource corresponding to an enhanced physical downlink control channel and a resource corresponding to a common search space of a physical downlink control channel (PDCCH);

The first sending module 22 is configured to send a feedback message to the base station, where the feedback message notifies the base station that the user equipment has switched to the enhanced physical downlink control channel mode. The second reception module 23 is configured to receive the control signaling transmitted by the base station over the resource corresponding to the enhanced physical downlink control channel and the resource corresponding to the common search space of the physical downlink control channel.

The first reception module 21 is further configured to receive first Radio Resource Control (RRC) signaling of the base station to instruct the user equipment to switch to the enhanced physical downlink control channel mode.

The first sending module 22 is further configured to send a first RRC feedback message to the base station.

The second reception module 23 is further configured to receive the control signaling transmitted by the base station to the user equipment over the resource corresponding to the common search space.

The first reception module 21 is further configured to receive second RRC signaling of the base station to instruct the user equipment to switch from the enhanced physical downlink control channel mode to a physical downlink control channel mode; and

The first sending module 22 is configured to send a second RRC feedback message to the base station, where the second RRC feedback message notifies the base station that the user equipment has switched to the physical downlink control channel mode.

The user equipment further includes a third reception module 24 and a fourth reception module 25.

The third reception module 24 is configured to receive a handover instruction of the base station to instruct the user equipment to be handed over from a current cell to an adjacent cell.

The fourth reception module 25 is configured to receive a higher-layer instruction of the base station to update a parameter configuration in the enhanced physical downlink control channel.

The user equipment further includes a second sending module 26.

The second sending module 26 is configured to send a feedback message for the higher-layer instruction to the user equipment, where the feedback message for the higher-layer instruction notifies the base station that the user equipment has updated the parameter configuration; and

The second reception module 23 is further configured to receive the control signaling transmitted by the base station according to the updated parameter configuration.

### Fourth Embodiment

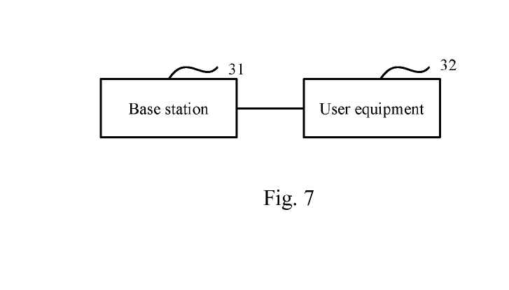

A fourth embodiment of the invention provides a system for transmitting control signaling, and as illustrated in FIG. 7, there is illustrated a schematic structural diagram of the system including a base station 31 and a user equipment 32.

The base station 31 is configured to instruct the user equipment via signaling to switch to an enhanced physical downlink control channel mode, where the signaling instructs the user equipment operating in the enhanced physical downlink control channel mode to detect control signaling over a resource corresponding to an enhanced physical downlink control channel and a resource corresponding to a common search space of a physical downlink control channel PDCCH, and to transmit the control signaling to the user equipment over the resource corresponding to the enhanced physical downlink control channel and the resource corresponding to the common search space upon reception of a feedback message of the user equipment, where the feedback message notifies the base station that the user equipment has switched to the enhanced physical downlink control channel mode; and

The user equipment 32 is configured to receive the signaling to instruct the user equipment to switch to the enhanced physical downlink control channel mode, and the control signaling, transmitted by the base station, and to return the feedback message to the base station.

The base station in this embodiment can be structurally the same as the base station in the second embodiment, and the respective functional units thereof can perform corresponding functions; and the user equipment in this embodiment can be structurally the same as the user equipment in the third embodiment, and the respective functional units thereof can perform corresponding functions.

In summary, an embodiment of the invention provides a system for transmitting control signaling, where not only a scheme to transmit control signaling to the user equipment in various statuses can be defined to thereby address the problem of an ambiguous period due to an indeterminate operating mode of the user equipment, but also blind detection in PDCCH and E-PDCCH search spaces can be avoided to thereby low the complexity of detection by the UE and consequently a cost of the equipment.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the essence and scope of the invention. Thus the invention is also intended to encompass these modifications and variations thereto so long as the modifications and variations come into the scope of the claims appended to the invention and their equivalents.

1. A method of transmitting control signaling comprising:
a base station instructing a user equipment via signaling to switch to an enhanced physical downlink control channel mode, wherein the signaling instructs the user equipment operating in the enhanced physical downlink control channel mode to detect control signaling over a resource corresponding to an enhanced physical downlink control channel and a resource corresponding to a common search space of a physical downlink control channel, PDCCH; and
the base station transmitting the control signaling to the user equipment over the resource corresponding to the enhanced physical downlink control channel and the resource corresponding to the common search space upon reception of a feedback message of the user equipment,
wherein the feedback message notifies the base station that the user equipment has switched to the enhanced physical downlink control channel mode.

2. The method of claim 1, wherein:
the base station instructing the user equipment via the signaling to switch to the enhanced physical downlink control channel mode comprises:
the base station instructing the user equipment via first Radio Resource Control, RRC, signaling to switch to the enhanced physical downlink control channel mode; and
the base station receiving the feedback message of the user equipment comprises:
the base station receiving a first RRC feedback message of the user equipment.

3. The method of claim 2, further comprising:
the base station transmitting the control signaling to the user equipment over the resource corresponding to the common search space after instructing the user equipment via the first RRC signaling to switch to the enhanced physical downlink control channel mode and before receiving the first RRC feedback message of the user equipment.

4. The method of claim 1, further comprising:
the base station transmitting the control signaling to the user equipment over the resource corresponding to the common search space after instructing the user equipment via second RRC signaling to switch from the enhanced physical downlink control channel mode to a physical downlink control channel mode and before receiving second RRC feedback message of the user equipment, wherein:
the second RRC feedback message notifies the base station that the user equipment has switched to the physical downlink control channel mode.

5. The method of claim 1, further comprising:
the base station transmitting the control signaling to the user equipment over the resource corresponding to the common search space after instructing the user equipment via a handover instruction to be handed over from a current cell to an adjacent cell and before determining that the user equipment has been handed over to the adjacent cell; and
after determining that the user equipment has been handed over to the adjacent cell, the base station judging whether a corresponding parameter configuration of the enhanced physical downlink control channel before the user equipment is handed over is available, and if so, then transmitting the control signaling to the user equipment over the resource corresponding to the enhanced physical downlink control channel and the resource corresponding to the common search space; otherwise, the base station instructing the user equipment via a higher-layer instruction to update the parameter configuration of the enhanced physical downlink control channel.

6. The method of claim 5, further comprising:
the base station transmitting the control signaling to the user equipment over the resource corresponding to the common search space after instructing the user equipment via the higher-layer instruction to update the parameter configuration of the enhanced physical downlink control channel and before receiving feedback message of the user equipment for the higher-layer instruction; and
the base station transmitting the control signaling to the user equipment according to the updated parameter configuration after receiving the feedback message of the user equipment for the higher-layer instruction, wherein:
the feedback message for the higher-layer instruction notifies the base station that the user equipment has updated the parameter configuration.

7. A base station comprising:
a first sending module configured to instruct a user equipment via signaling to switch to an enhanced physical downlink control channel mode, wherein the signaling instructs the user equipment operating in the enhanced physical downlink control channel mode to detect control signaling over a resource corresponding to an enhanced physical downlink control channel and a resource corresponding to a common search space of a physical downlink control channel, PDCCH;
a reception module configured to receive a feedback message of the user equipment, wherein the feedback message notifies the base station that the user equipment has switched to the enhanced physical downlink control channel mode; and
a signaling transmission module configured to transmit the control signaling to the user equipment over the resource corresponding to the enhanced physical downlink control channel and the resource corresponding to the common search space after the reception module receives the feedback message.

8. The base station of claim 7, wherein:
the first sending module is further configured to instruct the user equipment via first Radio Resource Control, RRC, signaling to switch to the enhanced physical downlink control channel mode; and
the reception module is further configured to receive a first RRC feedback message of the user equipment.

9. The base station of claim 8, wherein:
the signaling transmission module is further configured to transmit the control signaling to the user equipment over the resource corresponding to the common search space after the first sending module instructs the user equipment to switch to the enhanced physical downlink control channel mode and before the reception module receives the first RRC feedback message of the user equipment.

10. The base station of claim 7, wherein:
the first sending module is further configured to instruct the user equipment via second RRC signaling to switch from the enhanced physical downlink control channel mode to a physical downlink control channel mode;
the reception module is further configured to receive a second RRC feedback message of the user equipment, wherein the second RRC feedback message notifies the base station that the user equipment has switched to the physical downlink control channel mode; and
the signaling transmission module is further configured to transmit the control signaling to the user equipment over the resource corresponding to the common search space after the first sending module instructs the user equipment to switch from the enhanced physical downlink control channel mode to a physical downlink control channel mode and before the reception module receives the second RRC feedback message of the user equipment.

11. The base station of claim 7, further comprising a second sending module, a determination module and a third sending module, wherein:
the second sending module is configured to instruct the user equipment via a handover instruction to be handed over from a current cell to an adjacent cell;
the determination module is configured to determine whether the user equipment has been handed over to the adjacent cell;
the signaling transmission module is further configured to transmit the control signaling to the user equipment over the resource corresponding to the common search space after the second sending module instructs the user equipment to be handed over from the current cell to the adjacent cell and before the determination module determines that the user equipment has been handed over to the adjacent cell, and after the determination module determines that the user equipment has been handed over to the adjacent cell, the signaling transmission module is further configured to judge whether a corresponding parameter configuration of the enhanced physical downlink control channel before the user equipment is handed over is available, and if so, to transmit the control signaling to the user equipment over the resource corresponding to the enhanced physical downlink control channel and the resource corresponding to the common search space; otherwise, to trigger the third sending module; and
the third sending module is configured to instruct the user equipment via a higher-layer instruction to update the parameter configuration of the enhanced physical downlink control channel.

12. The base station of claim 11, wherein:
the reception module is further configured to receive a feedback message of the user equipment for the higher-layer instruction, wherein the feedback message for the higher-layer instruction notifies the base station that the user equipment has updated the parameter configuration; and
the signaling transmission module is further configured to transmit the control signaling to the user equipment over the resource corresponding to the common search space after the third sending module comprised in the base station instructs the user equipment via the higher-layer instruction to update the parameter configuration of the enhanced physical downlink control channel and before the reception module receives the feedback message of the user equipment for the higher-layer instruction, and to transmit the control signaling according to the updated parameter configuration after the reception module receives the feedback message of the user equipment for the higher-layer instruction.

13. A user equipment comprising:
a first reception module configured to receive signaling of a base station to instruct the user equipment to switch to an enhanced physical downlink control channel mode, wherein the signaling instructs the user equipment operating in the enhanced physical downlink control channel mode to detect control signaling over a resource corresponding to an enhanced physical downlink control channel and a resource corresponding to a common search space of a physical downlink control channel, PDCCH;
a first sending module configured to send a feedback message to the base station, wherein the feedback message notifies the base station that the user equipment has switched to the enhanced physical downlink control channel mode, and
a second reception module configured to receive the control signaling transmitted by the base station over the resource corresponding to the enhanced physical downlink control channel and the resource corresponding to the common search space of the physical downlink control channel.

14. The user equipment of claim 13, wherein:
the first reception module is further configured to receive first Radio Resource Control, RRC, signaling of the base station to instruct the user equipment to switch to the enhanced physical downlink control channel mode; and
the first sending module is further configured to send a first RRC feedback message to the base station.

15. The user equipment of claim 13, wherein:
the second reception module is further configured to receive the control signaling transmitted by the base station to the user equipment over the resource corresponding to the common search space.

16. The user equipment of claim 13, wherein:
the first reception module is further configured to receive second RRC signaling of the base station to instruct the user equipment to switch from the enhanced physical downlink control channel mode to a physical downlink control channel mode; and
the first sending module is configured to send a second RRC feedback message to the base station, wherein the second RRC feedback message notifies the base station that the user equipment has switched to the enhanced physical downlink control channel mode.

17. The user equipment of claim 13, further comprising:
a third reception module configured to receive a handover instruction of the base station to instruct the user equipment to be handed over from a current cell to an adjacent cell; and
a fourth reception module configured to receive a higher-layer instruction of the base station to update a parameter configuration in the enhanced physical downlink control channel.

18. The user equipment of claim 17, further comprising:
a second sending module configured to send a feedback message for the higher-layer instruction to the base station, wherein the feedback message for the higher-layer instruction notifies the base station that the user equipment has updated the parameter configuration, wherein:
the second reception module further configured to receive the control signaling transmitted by the base station according to the updated parameter configuration.

19. (canceled)
